(19) United States
(12) Patent Application Publication
(10) Pub. No.: US 2023/0216099 A1
(43) Pub. Date: Jul. 6, 2023

(54) LITHIUM-ION BATTERY AND OPTICAL COMMUNICATION SYSTEM

(71) Applicant: APB Corporation, Tokyo (JP)

(72) Inventors: Hideaki HORIE, Tokyo (JP); Yohji KAWASAKI, Kyoto (JP); Yusuke MIZUNO, Kyoto (JP); Kotaro NASU, Kyoto (JP)

(73) Assignee: APB Corporation, Tokyo (JP)

(21) Appl. No.: 17/927,790

(22) PCT Filed: May 26, 2021
(86) PCT No.: PCT/JP2021/020042

§ 371 Date: Nov. 25, 2022

(30) Foreign Application Priority Data
May 26, 2020 (JP) 2020-091368
Jul. 20, 2020 (JP) 2020-123666

(51) Int. Cl. H01M 10/48; H04B 10/69; H04B 10/516; H01M 10/0525; H01M 10/0585; H01M 50/105; H01M 50/124; H01M 10/42

(52) U.S. Cl. CPC H01M 10/488; H04B 10/69; H04B 10/516; H01M 10/0525; H01M 10/0585; H01M 50/105; H01M 50/124; H01M 10/425; H01M 10/486

(57) ABSTRACT

The present disclosure provides a lithium-ion battery with the configuration where optical signals are output from the light-emitting parts of each unit cell that constitutes the assembled battery, wherein the complexity of wiring can be reduced, and the allowable amount of misalignment can be increased. In a lithium-ion battery (1) in which an assembled battery (50) configured by a plurality of laminated unit cells (30) is accommodated in an outer package (70), each of the unit cell is provided with a light-emitting part (20) that emits light based on the characteristics of the unit cell concerned to output an optical signal, and an optical waveguide (light guide plate) (60) is arranged adjacent or close to a light-emitting surface of the light-emitting part to be a common transmission path of the optical signal from the light-emitting part of the plurality of unit cells.

### TECHNICAL FIELD

The present disclosure relates to a lithium-ion battery and an optical communication system.

### BACKGROUND ART

Conventionally, assembled batteries consisting of a plurality of lithium-ion battery unit cells laminated together have been used as power sources for power-supply portable type electronic devices such as electric vehicles and hybrid electric vehicles. When charging such an assembled battery, it is necessary to manage the charging so that there are no unit cells that are overcharged.

Patent Literature 1 describes the feature in which the voltage across the terminals of each unit cell in the battery pack is transmitted to an external charging device through electrical connections such as metal wiring and terminals (see paragraph 0040 and FIG. 4 of Patent Literature 1).

### CITATION LIST

### Patent Literature

PTL 1: International Publication No. 2009/119075
PTL 1: Japanese Patent Laid-Open No. HEI 11-341693

### SUMMARY OF INVENTION

As described above, when transmitting information on the characteristics of each unit cell in the battery pack to an external device through the electrical connection, the number of wirings and terminals increases in accordance with the number of unit cells, and therefore the problem of increase in weight and space arises due to the number of wirings and terminals. Further, if electrical wiring is installed, there also arises the problem of a risk of short circuits between unit cells, and complicated wiring.

For the purpose of solving such a problem, there is a concept of using optical fibers to transmit optical signals. For example, Patent Literature 2 discloses that an overcharge heat generation circuit including a light emitting diode is connected in parallel to both the ends of a battery module including unit cells connected in series, and when overcharging occurs, the light emitted from the light-emitting diode is sent to the light receiving diode via a common optical fiber (for example, see Patent Literature 2, paragraphs 0012, 0023 to 0024, and FIG. 5).

However, the technology described in Patent Literature 2 has solved the risk of short-circuiting between the unit cells by adopting the means of optical fibers, however, the optical fibers also require wiring connections in the same way as the electrical wiring described above. Therefore, the wiring required a lot of work, and the above-described problem has still not been solved. Further, if the optical signals are collectively transmitted by the optical fiber, strict alignment is required, so that there also has been a problem the problem of being vulnerable to misalignment.

The present disclosure has been made for solving this problem, and the purpose thereof is to provide a lithium-ion battery with the configuration where optical signals are output from the light-emitting parts of each unit cell that constitutes the assembled battery, wherein the complexity of wiring can be reduced, and the allowable amount of misalignment can be increased.

In order to achieve such an object, the lithium-ion battery according to an embodiment of the invention of the present application comprises:

a plurality of unit cells that is laminated, each of the unit cells having a measuring part that measures characteristics of the unit cells and a light-emitting part that emits light based on the characteristics of the unit cell and outputs an optical signal;

an optical waveguide arranged adjacent or close to a light-emitting surface of the light-emitting part, the optical waveguide having an optical output part that emits the incident and propagated optical signal; and

an outer package for accommodating the plurality of batteries and the optical waveguide,

wherein the optical waveguide is a common transmission path the optical signal from the plurality of unit cells.

As explained above, according to the present disclosure, it is configured that an optical signal output from a light-emitting part of each unit cell that constitutes an assembled battery accommodated in an outer package of a lithium-ion battery is transmitted through the optical waveguide that is a common transmission path, thereby the complexity of wiring can be reduced and the allowable amount of misalignment can be increased.

Furthermore, the configuration of Patent Literature 2 is that the light is emitted when a unit cell is overcharged and the corresponding light-emitting diode is energized, so that the light cannot be emitted in accordance with the characteristics such as temperature and voltage for each predetermined period. Further, the configuration of Patent Literature 2 is that the light emitted from multiple light-emitting diodes is sent to the light-receiving diode through a common optical fiber, it is only possible to decide that at least one unit cell is overcharged when light emission is detected on the light receiving diode.

The present disclosure has been made for solving this problem, and the purpose thereof is to provide an optical communication system in which each light-emitting part outputs an optical signal corresponding to the characteristics of the corresponding unit cell to the common optical waveguide for each predetermined period; and also the purpose thereof is to provide an optical communication system capable of deciding or estimating which of the characteristics the optical signal indicates.

In order to achieve the object above, the optical communication system according to an embodiment of the invention of the present application comprises a plurality of optical transmitters provided in the plurality of laminated unit cells constituting the lithium-ion battery, wherein each of unit cells has an optical transmitter, and each optical transmitter is provided with:

the control part configured to receive a characteristic signal indicating the characteristics of the corresponding unit cell, and output a control signal obtained by encoding the characteristic signal for each predetermined period; and

the light-emitting part for outputting an optical signal corresponding to the control signal to the transmission path common to the plurality of optical transmitters, and

the plurality of optical transmitters is configured to asynchronously transmit the optical signal.

Further, the optical communication system according to the other embodiment comprises a light receiving part for receiving the optical signal and converting the signal into an electrical signal, and a signal processing part configured to process the electrical signal to decide or estimate the state of each of the plurality of unit cells.

As described above, according to the present disclosure, it is possible to provide an optical communication system in which each light-emitting part outputs an optical signal corresponding to the characteristics of the corresponding unit cell to the common optical waveguide for each predetermined period. Further, according to an embodiment of the present invention, it is also possible to provide an optical communication system capable of deciding or estimating which of the characteristics the optical signal indicates.

### BRIEF DESCRIPTION OF DRAWINGS

FIG. 1 is a diagram showing a configuration of a lithium-ion battery to which an optical communication system according to one embodiment of the present invention can be applied; FIG. 1(a) is a partially cutaway perspective view; and FIG. 1(b) is a perspective view showing the exterior.

FIG. 2 is a diagram showing a schematic cross-sectional structure of the lithium-ion battery shown in FIG. 1.

FIG. 3 is a diagram showing the configuration of the lithium-ion battery 1 according to other embodiment of the present invention; FIG. 3(a) is a partially cutaway perspective view; and FIG. 3(b) is a perspective view showing the exterior.

FIG. 4 is a diagram showing a variation of the lithium-ion battery 1 shown in FIG. 3.

FIG. 5 is a diagram showing the optical waveguide that is provided in the lithium-ion battery according to other embodiment; FIG. 5(a) is a diagram showing the optical waveguide (light guide plate) with a conical (linearly tapered) cross-sectional shape; and FIG. 5(b) is a diagram showing the optical waveguide (light guide plate) with a cross-sectional shape of an exponential function taper or parabolic taper.

FIG. 6 is a diagram showing a schematic configuration of a plurality of optical transmitters in the optical communication system of an embodiment of the present invention.

FIG. 7 is a diagram showing a schematic configuration of a clock generation circuit for the optical transmitter in the optical communication system according to an embodiment of the present invention.

FIG. 8 is a functional block diagram of the measurement circuit 90 of the optical transmitter of an embodiment of the present invention.

FIG. 9 is a diagram explaining the optical signals transmitted by the plurality of optical transmitters in a certain time period (ideal transmission timing within the system cycle) in the optical communication system of an embodiment of the present invention; FIGS. 9(a), 9(b), and 9(c) are diagrams showing the optical signals output from the optical transmitters different from one another on the time axis; and FIG. 9(d) is a diagram showing the optical signal in FIGS. 9(a), 9(b), and 9(c) in the common optical waveguide on the time axis.

FIG. 10 is a diagram explaining the optical signals transmitted by the plurality of optical transmitters in another time period (ideal transmission timing within the system cycle) in the optical communication system of an embodiment of the present invention; FIGS. 10(a), 10(b), and 10(c) are diagrams showing the optical signals output from the optical transmitters different from one another on the time axis; and FIG. 10(d) is a diagram showing the optical signal in FIGS. 10(a), 10(b), and 10(c) in the common optical waveguide on the time axis.

FIG. 11 is a diagram explaining the timing when the optical transmitter sends an optical signal in the optical communication system in an embodiment of the present invention; FIG. 11(a) is a diagram showing a clock of the optical transmitter; FIG. 11(b) is a diagram showing a characteristic signal from the measurement circuit; FIG. 11(c) is a diagram showing a signal indicating a certain period; and FIG. 11(d) is a diagram showing an optical signal output by the light-emitting part emitting light in accordance with a control signal from the control circuit

FIG. 12 is a functional block diagram of the optical communication system in an embodiment of the present invention

FIG. 13 is a flowchart of signal processing by a signal processing device of the optical communication system of an embodiment of the present invention.

### DESCRIPTION OF EMBODIMENTS

Hereinafter, embodiments of the present invention will be described in detail with reference to the drawings. Like or similar symbols indicate the like or similar elements, and repeated description may be omitted. Numerical values and materials described below are exemplifications, and therefore, it is needless to say that the present invention can be implemented using other numerical values and materials without departing from the gist thereof.

A lithium-ion battery according an embodiment of the present invention is provided with a plurality of unit cells that is laminated, each of the unit cells having a measuring part that measures characteristics of the unit cells and a light-emitting part that emits light based on the characteristics of the unit cell and outputs an optical signal; an optical waveguide arranged adjacent or close to a light-emitting surface of the light-emitting part, the optical waveguide having an optical output part that emits the incident and propagated optical signal; and an outer package for accommodating the plurality of batteries and the optical waveguide, wherein the optical waveguide is a common transmission path the optical signal from the plurality of unit cells. A part of the optical waveguide may be led out of the outer package and bonded to the outer package to serve as an optical output part. Alternatively, the entire optical waveguide including the optical output part may be accommodated in the outer package.

The optical communication system according to an embodiment of the invention of the present application comprises a plurality of optical transmitters provided in the plurality of laminated unit cells constituting the lithium-ion battery, wherein each of unit cells has an optical transmitter. Each optical transmitter is provided with the control part configured to receive a characteristic signal indicating the characteristics of the corresponding unit cell, and output a control signal obtained by encoding the characteristic signal for each predetermined period; and the light-emitting part for outputting an optical signal corresponding to the control signal to the transmission path common to the plurality of optical transmitters. The plurality of optical transmitters is configured to asynchronously transmit the optical signal.

Typically, the unit cell is formed by laminating a positive electrode current collector, a positive electrode active material layer, a separator, a negative electrode active material layer, and a negative electrode current collector in this order from the bottom. The unit cell is formed by laminating a positive electrode in which a positive electrode active material layer is formed on the surface of a substantially rectangular flat plate-shaped positive electrode current collector, and a negative electrode active material layer formed on the surface of a substantially rectangular flat plate-shaped negative electrode current collector with a substantially flat plate-shaped separator interposed therebetween. In the unit cell, an annular frame member is arranged between the positive electrode current collector and the negative electrode current collector, and the frame member fixes the peripheral edge portion of the separator between the positive electrode current collector and the negative electrode current collector, and also seals the positive electrode active material layer, the separator, and the negative electrode active material layer. For example, the light emitting part or a light emitting/receiving part may be embedded in or attached to the frame member so as to be exposed on the side surface of the frame member.

### First Embodiment

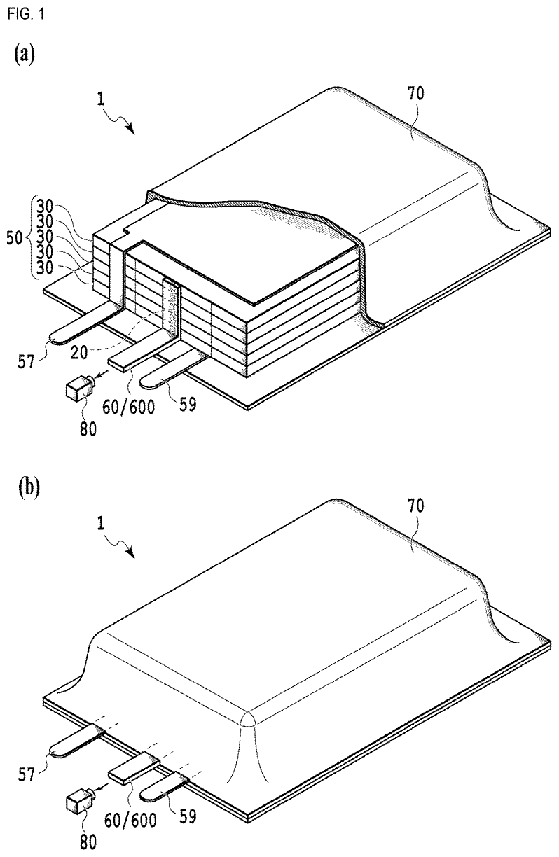

FIG. 1 is a diagram showing a configuration of a lithium-ion battery according to the first embodiment of the present invention; FIG. 1(a) is a partially cutaway perspective view, and FIG. 1(b) is a perspective view showing the exterior.

As shown in FIG. 1, a lithium-ion battery 1 has a plurality of laminated unit cells 30. The lithium-ion battery 1 also has an optical waveguide 60 (light guide plate) arranged adjacent or close to a light-emitting surface of a light-emitting part 20. Further, the lithium-ion battery 1 has an outer package 70 that accommodates the plurality of unit cells 30 and the optical waveguide 60.

The plurality of laminated unit cells 30 constitutes an assembled battery 50. FIG. 1 shows an aspect in which five unit cells 30 are laminated, however, the number of laminated unit cells may be more than five or less than five. In an embodiment, the number of laminated unit cells 30 may be 20 or more. Each of the unit cells 30 includes a negative electrode current collector (not shown) and a positive electrode current collector (not shown) facing the negative electrode current collector. Two adjacent unit cells 30 in the assembled battery 50 are laminated such that the upper surface of the negative electrode current collector of one of the unit cells 30 and the lower surface of the positive electrode current collector of the other unit cell 30 are adjacent to each other. FIG. 1 shows the assembled battery 50 with five unit cells 30 connected in series.

The positive electrode current collector and the negative electrode current collector may constituted by using any of metal materials such as copper, aluminum, titanium, stainless steel, nickel, and alloys thereof, calcined carbon, conductive polymeric material, and conductive glass.

A conductive sheet is provided on the negative electrode current collector on the uppermost surface of the assembled battery 50. A part of the conductive sheet is led out from the outer package 70 to form a lead wiring 57. Further, a conductive sheet is provided under the positive electrode current collector on the lowermost surface of the assembled battery 50. A part of the conductive sheet is led out from the outer package 70 to form lead wiring 59. The conductive sheet may be constituted by using any of metal materials such as copper, aluminum, titanium, stainless steel, nickel and the alloys thereof, but is not limited to these materials as long as they have conductivity. The conductive sheet may be constituted using a conductive polymer material.

Each of the unit cells 30 has a measuring part (not shown) that measures the characteristics of the unit cell and a light-emitting part 20 that emits light based on the measured characteristics and outputs an optical signal.

The measuring part may be configured to measure the voltage of the unit cell 30 and control the light emission of the light-emitting part 20 based on the measured voltage. More specifically, the measuring part is provided with a voltage measuring terminal (not shown) in contact with both the positive electrode current collector and the negative electrode current collector, and a control element (not shown) electrically coupled to the voltage measuring terminal and electrically coupled to the light-emitting part 20. The control element may be configured using arbitrary semiconductor elements such as IC, LSI, and the like. The control element is configured to be supplied with power from the unit cell 30 and supply a control signal corresponding to the voltage across the positive electrode current collector and the negative electrode current collector to the light-emitting part 20.

The light-emitting part 20 may be configured using light-emitting elements such as LED elements, organic EL elements, and the like. The light-emitting part 20 may be configured to be supplied with power from the unit cell 30 and configured to be driven (i.e., emit light) based on the control signal from the control element constituting the measuring part.

The light-emitting part 20 is arranged on one of the short sides of the unit cells 30. Preferably, with the plurality of unit cells 30 laminated, the light-emitting surfaces of the plurality of light-emitting parts 20 are arranged in a row on the side surface of the assembled battery 50 in the lamination direction of the plurality of unit cells 30.

The optical waveguide 60 has an optical output part from which the incident and propagated optical signal is emitted. In this embodiment, a part of the optical waveguide 60 is led out from the outer package 70 to be the optical output part. The optical signal emitted from the optical output part is received by a light receiving part 80. The light receiving part 80 may be constructed using a photodiode, a phototransistor, etc. An LED element, which is a light-emitting element, may be used as a light-receiving element to configure the light receiving part 80. In addition, as described above. the optical waveguide 60 including the optical output part may be entirely accommodated in the outer package 70. In this case, as will be described later, it is not necessary to closely attach a part of the optical waveguide 60 to the outer package 70. When the entire optical waveguide 60 is accommodated in the outer package 70, the optical signal emitted from the optical output part is received by the light receiving part 80 arranged inside the outer package 70.

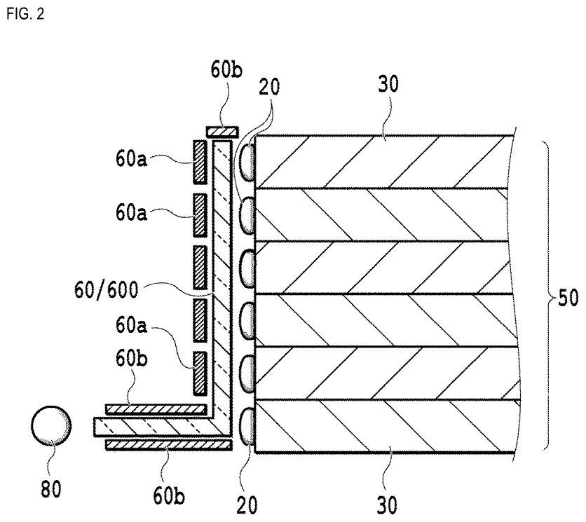

FIG. 2 is a diagram showing a schematic cross-sectional structure of the lithium-ion battery shown in FIG. 1. As shown in FIG. 2, an optical waveguide 60 extending in the lamination direction of the unit cells is arranged adjacent or close to the light emitting surface of the light-emitting part 20. The optical waveguide 60 has a sufficient width (the length in the direction perpendicular to the lamination direction of the unit cells) to receive the signal from the light-emitting part 20. The widthwise dimension of the optical waveguide 60 is greater than the maximum dimension of the light-emitting surface of the light-emitting part 20 (that is a diameter if the light-emitting surface is circular, or a diagonal line if the light-emitting surface is rectangular). The optical waveguide 60 is arranged to cover the light-emitting surfaces (each corresponding to the plurality of laminated unit cells) (preferably, cover all of the light-emitting surfaces). The optical waveguide 60 is arranged to cover all the light-emitting direction of the light-emitting part 20 (including a case where the light-emitting direction coincides with the vertical direction of the light-emitting surface and is inclined from the vertical direction of the light emitting surface). In addition, the widthwise dimension of the optical waveguide 60 (the lamination direction corresponding to the light-emitting part 20 of a single unit cell) is not particularly limited, but is preferably larger than the thickness (thickness in the lamination direction) of the unit cell, for example.

The optical waveguide 60 is configured by a material with a high refractive index relative to the refractive index of the surrounding medium (e.g., air); where high refractive index refers to the index of refraction having a value that the difference between the refractive index of the surrounding medium allows incident light to be confined within the optical waveguide and propagated. For example, the optical waveguide 60 can be configured using a high refractive index resin film or resin plate. Preferably, the optical waveguide 60 is configured using a deformable resin film or resin plate to the extent that a bent portion of about 90 degrees can be formed. The deformable resin film or resin plate may be soft at normal or room temperature, or hard at normal or room temperature. The optical waveguide 60 may be configured so that, of the surfaces of the optical waveguide 60 facing the light-emitting surface of the light-emitting part 20, only a light input portion (the portion adjacent or close to the light-emitting surface of the light-emitting part 20) and the optical output part are free of low refractive index material (the confinement ability is reduced), and cover the portion other than the input part and the optical output part (back and side surfaces of the optical waveguide 60) with a material with a lower refractive index than the vacuum.

The resin forming the resin film or resin plate that constitutes the optical waveguide 60 may be, but is not limited to, an acrylic resin or the like. For example, for the resin film or resin plate, a flexible resin with a high refractive index called an optical material can be selected. A resin that forms a resin film or a resin plate constituting the film optical waveguide 60 made of a material that does not easily absorb the light emission wavelength band of the light emitting element is preferable. If the emission wavelength band of the light emitting element is infrared light, it is desirable to use a film made of a material with a low infrared absorption peak between 850 nm and 950 nm.

The optical waveguide 60 is applied with a scattering finishing 60a at a position on the back surface corresponding to the position on the surface that receives the optical signal. The scattering finishing 60a is applied to the position corresponding to the light emitting surface of the adjacent or proximity light-emitting part 20. The scattering finishing 60a may be, for example, an uneven finish. A part of the optical signal that is incident on the optical waveguide 60 and scattered by the scattering finishing 60a propagates in the direction of the optical output part.

The optical waveguide 60 is applied with a reflective finishing 60b on the bent portion, which allows the optical signal scattered by the bent portion to be reflected in the direction of the optical output part. The reflective finishing 60b is applied to the end portion opposite to the end portion that is the optical output part of the optical waveguide 60, which allows the light scattered in the direction opposite to the optical output part to be reflected in the direction of the optical output part.

Referring again to FIG. 1, the outer package 70 can be configured using a metal can case or a polymer metal composite film. The outer package 70 is sealed so as to maintain the internal pressure reduction.

With the above configuration, the lithium-ion battery of the present embodiment can receive and use the optical signal, which is output from the light-emitting part of each of the unit cells that constitutes the assembled battery accommodated in the outer package, outside or inside the outer package.

As described above, since the lithium-ion battery of this embodiment uses an optical waveguide (light guide plate) as a common transmission path for transmitting the optical signal output from the light-emitting part of each of the unit cells that constitutes the assembled battery, the complexity of positioning the common transmission path can be reduced or the misalignment tolerance can be increased compared to using an optical fiber as a common transmission path.

Further, since an optical waveguide (light guide plate) is used as a common transmission path, the optical signal output from the light-emitting part is more easily received than in the case where an optical fiber is used as a common transmission path. Therefore, even if the relative positions of the light-emitting part and the common transmission path change due to change in the volume of the unit cell during charging and discharging, the tolerance to misalignment between the light-emitting part and the common transmission path that can occur due to such changes is increased. Further, since the optical waveguide (light guide plate) is used as a common transmission path, it is possible to efficiently receive the optical signal over a relatively wide area, which eliminates the need for additional parts such as lenses to collect the optical signal output from the light-emitting part to make the signal incident to the common transmission path.

Further, since the optical waveguide made of a deformable resin film is used as a common transmission path, even if the position of the light-emitting part changes due to unit cell deformation, etc., it becomes possible to easily adjust the relative positions of the light-emitting part and the common transmission path by following the changes in position and deforming the common transmission path.

### Second Embodiment

This embodiment provides the lithium-ion battery 1 using the outer package 70 configured using a polymer-metal composite film. The assembled battery 50 including the plurality of laminated unit cells 30 is accommodated in the outer package 70 configured using a laminate film (polymer metal composite film) in which aluminum foil or steel foil and plastic film are laminated. The interior of the outer package 70 is maintained in a decompressed state.

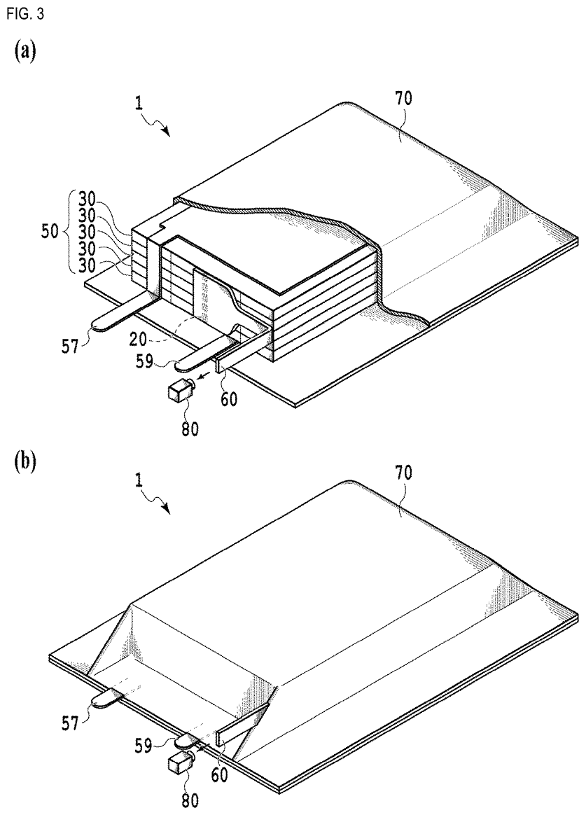

FIG. 3 is a diagram showing the configuration of the lithium-ion battery 1 according to a second embodiment of the present invention. FIG. 3(a) is a partially cutaway perspective view, and FIG. 3(b) is a perspective view showing the exterior.

Similar to the lithium-ion battery 1 shown in FIG. 1, the lithium-ion battery 1 of this embodiment has the plurality of laminated unit cells 30. The lithium-ion battery 1 also has the optical waveguide (light guide plate) 60 arranged adjacent or close to a light-emitting surface of the light-emitting part 20. The lithium-ion battery 1 also has the outer package 70 that accommodates the plurality of unit cells 30 and the optical waveguide 60.

As shown in FIG. 3, the optical waveguide 60 extending in a direction substantially perpendicular to the lamination direction of the unit cells is arranged adjacent or close to the light-emitting surface of the light-emitting part 20. The optical waveguide 60 has a sufficient width (length in the lamination direction of the unit cells) to receive optical signals from the plurality of light-emitting parts 20 aligned in the unit cell laminating direction. Since the optical waveguide 60 in the lithium-ion battery 1 shown in FIG. 1 has a configuration to extend in the lamination direction of the plurality of unit cells 30, increase in the number of the laminating unit cells 30 may make the propagation distance of the optical signal longer, whereby decreasing light intensity at the optical output part. On the other hand, in the optical waveguide 60 extending in a direction substantially perpendicular to the lamination direction of the unit cells as in the present embodiment, the propagation distance of the optical signal that becomes longer with increase in the number of the laminating unit cells 30 can be made smaller, whereby the possibility of decrease in the light intensity at the optical output part can be reduced.

Similar to the embodiment described with reference to FIG. 1, the optical waveguide 60 is configured using a deformable resin film or resin plate to the extent that a bent portion of about 90 degrees can be formed. Further, the optical waveguide 60 may be applied with a scattering finishing 60a at a position on the back surface corresponding to the position on the surface that receives the optical signal where the position corresponds to the light emitting surface of the adjacent or proximity light-emitting part 20. A part of the optical signal that is incident on the optical waveguide 60 and scattered by the scattering finishing 60a propagates in the direction of the optical output part. The optical waveguide 60 may have a reflective finishing 60b on the bent portion.

The assembled battery 50 is accommodated using two laminate films that configures the outer package 70. More specifically, the assembled battery 50 arranged on a planar laminate film is covered with a second laminate film that is folded in a box shape, and then the inside thereof is decompressed and the edge of the first laminate film to the edges of the second laminate film are heat-sealed, so that the assembled battery 50 can be accommodated inside the outer package 70.

A part of the conductive sheet provided on the negative electrode current collector on the uppermost surface of the assembled battery 50 is led out from the edge of the outer package 70 (the part where the first laminate film and the second laminate film overlap) to be a lead wiring 57. Similarly, a part of the conductive sheet provided on the positive electrode current collector on the lowermost surface of the assembled battery 50 is led out from the edge of the outer package 70 to be a lead wiring 59. The lead wiring 57 and the lead wiring 59 are closely bonded to the edge of the first laminate film and the edge of the second laminate film, respectively.

A part of the optical waveguide 60 is led out from a cutout (slit), which is formed along the folded line of the mountain-folded portion of the second laminate film folded in a box shape, and serves as an optical output part. The optical output part is closely bonded to the mountain-folded portion in the second laminate film by heat sealing (the front and back surfaces of the optical output part are closely bonded to the second laminate film).

As shown in FIG. 3, in the optical waveguide 60, a bent portion is formed in accordance with the position of the mountain-folded portion (the position of the slit) in the second laminate film. Since the optical waveguide 60 is formed using a resin film or a resin plate that is deformable at room temperature or in the temperature range in which the battery is used, the bent portion can be easily formed in the manufacturing process. The optical waveguide 60 may be formed of a resin that is rigid at normal or room temperature, in which case the bent portions of the optical waveguide 60 may be temporarily deformed by heat treatment during the manufacturing process. In a case where the optical waveguide 60 is formed of a resin that is hard at normal or room temperature, the range of adjustment of the relative position between the light-emitting part 20 and the optical waveguide 60 by deforming the optical waveguide 60 following the misalignment, which may occur due to changes in the volume of the single unit cell, between the light-emitting part and the optical waveguide 60 as being the common transmission path may be reduced compared to the case where the optical waveguide 60 is formed of a resin that is soft at normal or room temperature.

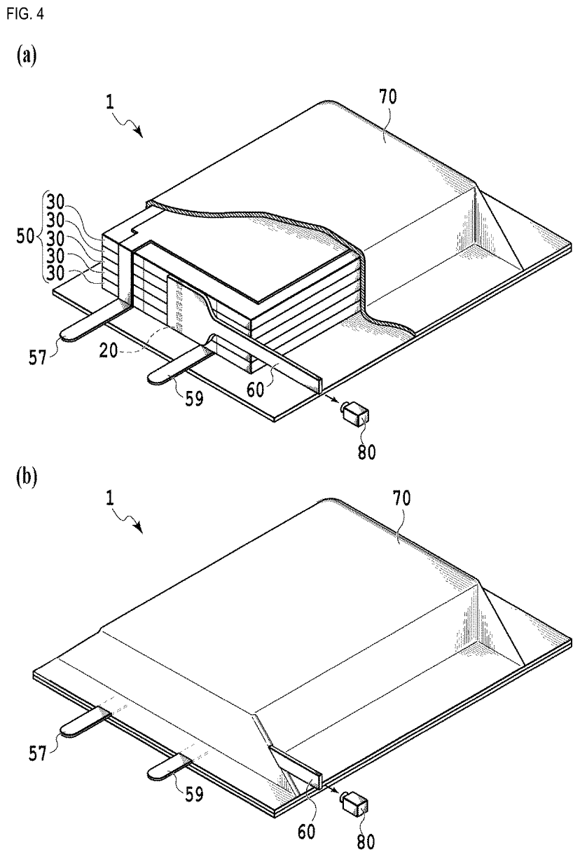

FIG. 4 is a diagram showing a variation of the lithium-ion battery 1 shown in FIG. 3. it does not contain a bent portion, scattering or reflection in The optical waveguide 60 of the lithium-ion battery 1 shown in FIG. 4 is different from the lithium-ion battery 1 in FIG. 3 in that the former does not include a bent portion. Since no bent portion is included, the scattering or reflection in the optical waveguide 60 is reduced, resulting in reduction of the loss of optical signal.

The width of the mountain-folded portion in the second laminate film that forms the outer package is decided in accordance with the width of the optical waveguide (light guide plate) 60. Considering the internal decompression in the manufacturing process and the close bonding of the edges of the laminate films, it is more advantageous to narrow the width of the optical waveguide (light guide plate) 60 to narrow the width of the slit.

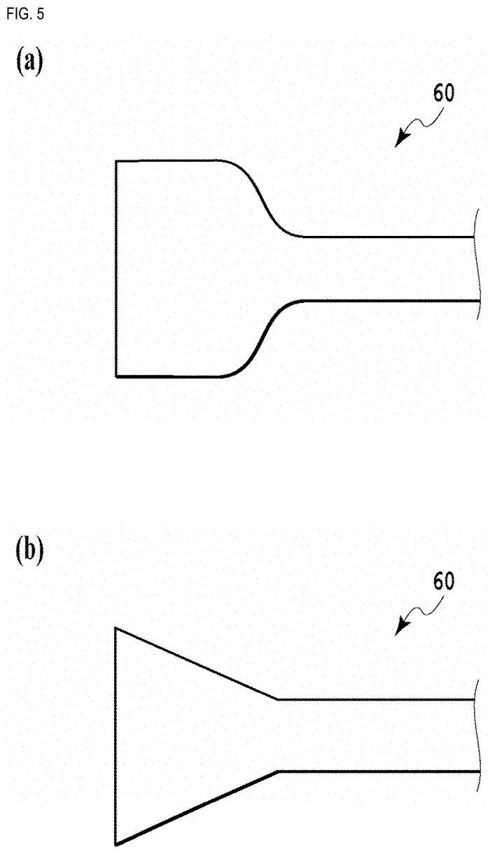

FIG. 5 is a diagram showing the optical waveguide 60 that is provided in the lithium-ion battery according to this embodiment. FIG. 5(a) is a diagram showing the optical waveguide (light guide plate) 60 with a conical (linearly tapered) cross-sectional shape, and FIG. 5(b) is a diagram showing the optical waveguide (light guide plate) 60 with a cross-sectional shape of an exponential function taper or parabolic taper.

Optionally, the shape of the optical waveguide 60 is made as the optical waveguide 60 shown in FIG. 5(a) or the optical waveguide 60 shown in FIG. 5(b), so that it is possible to reduce the propagation loss to allow the optical signal to be propagated with high efficiency and also reduce the width of the optical waveguide (light guide plate) 60.

With the above configuration, the lithium-ion battery of this embodiment can receive and use the optical signal output from the light-emitting part of each of the unit cells constituting the assembled battery accommodated in the outer package outside the outer package.

As described above, since the lithium-ion battery of this embodiment uses an optical waveguide (light guide plate) as a common transmission path for transmitting the optical signal output from the light-emitting part of each of the unit cells that constitutes the assembled battery, the complexity of positioning the common transmission path can be reduced or the misalignment tolerance can be increased compared to using an optical fiber as a common transmission path. In particular, considering the possibility of misalignment of the optical fiber due to the deformation of the outer package when decompressing the inside of the outer package, which can occur when the optical fiber is used as a common transmission path, the lithium-ion battery of this embodiment is remarkable.

The outer package 70 of the lithium-ion battery described with reference to FIG. 1 may be configured using the first laminate film and the second laminate film as described with reference to FIG. 3. In this case, a part of the optical waveguide 60 extending in the direction in which the light-emitting parts 20 are aligned is led from the edge of the outer package 70 (flat portion where the first laminate film and the second laminate film overlap) and closely bonded to the edges of the first and second laminate films by heat sealing to form the optical output part.

Various embodiments and modifications thereof have been described above, however, it goes without saying that the present invention can be implemented by replacing some or all of the constituent features or by adding constituent features without departing from the scope of the invention.

### Third Embodiment

Next, an optical communication system of an embodiment of the present disclosure will be described. The optical communication system of this embodiment can be applied to the lithium-ion battery of the embodiment described above. FIG. 1 is a partially cutaway perspective view of a lithium-ion battery to which an optical communication system according to an embodiment of the present invention can be applied. As shown in FIG. 1, the lithium-ion battery 1 has the plurality of laminated unit cells 30. Further, the lithium-ion battery 1 also has an optical waveguide 600 arranged adjacent or close to the light-emitting surface of the light-emitting part 20. Further, the lithium-ion battery 1 has the outer package 70 that accommodates the plurality of unit cells 30 and the optical waveguide 600.

Each of the unit cells 30 has a measurement circuit 90 that measures the characteristics of the unit cell concerned. Each of the unit cells 30 also has the light-emitting part 20 that emits light based on the measured characteristics and outputs an optical signal. The measurement circuit 90 and the light-emitting part 20 are provided in the optical transmitter 10 together with control circuit 40. The optical transmitter 10 will be described below.

The optical waveguide 600 has an optical output part that emits the incident and propagated optical signal. In an implementation example, the light emitted from the light emitting parts 20 provided in each of the 20 pieces or more of the unit cells 30 that are arranged adjacent or close to a single optical waveguide 600 is optically coupled and emitted from the light output part. In this embodiment, a part of the light waveguide 600 is led out from the outer package 70 to be a light output part. The optical signal emitted from the light output part is received by the light receiving part 80. The light-receiving part 80 can be configured using a photodiode, phototransistor, or the like. The light receiving part 80 may be configured using an LED element, which is a light emitting element, as the light receiving element. The entire light waveguide 600 including the light output part may be accommodated inside the outer package 70. When the entire optical waveguide 600 is accommodated inside the outer package 70, the optical signal emitted from the optical output part is received by the light receiving part 80 arranged inside the outer package 70.

The outer package 70 can be configured using a metal can case or a polymer-metal composite film. The outer package 70 is sealed so as to maintain the internal pressure reduction.

As shown in FIG. 2, the optical waveguide 600 extending in the lamination direction of the unit cells is arranged adjacent to or close to the light emitting surface of the light emitting section 20. The optical waveguide 600 may be, for example, an optical fiber, or may be a light guide plate having a width sufficient to receive the optical signal from the light-emitting part 20 (the length in the direction perpendicular to the lamination direction of the unit cells). When the optical waveguide 600 is configured by a light guide plate, it is preferred that the widthwise dimension of the optical waveguide 600 is larger than the maximum dimension of the light emitting surface of the light-emitting part 20 (that is a diameter if the light-emitting surface is circular, or a diagonal line if the light-emitting surface is rectangular). FIG. 2 shows a case where the optical waveguide 600 is configured using a light guide plate.

When the light guide plate is used as the optical waveguide 600, the optical waveguide 60 can be arranged to cover all of the light-emitting surfaces (each corresponding to the plurality of laminated unit cells) of the plurality of light-emitting parts 20. The optical waveguide 60 can be arranged to cover the light-emitting direction of the light-emitting part 20 (including a case where the light-emitting direction coincides with the vertical direction of the light-emitting surface and is inclined from the vertical direction of the light emitting surface).

As described above, the use of a light guide plate as the optical waveguide 600 results in making the optical signal output from the light-emitting part 20 more easily to be received than in the case where an optical fiber is used as the optical waveguide 600, eliminating the necessity of additional components such as lenses for focusing light from the light-emitting part 20 to the optical waveguide 600, reducing the labor for positioning the optical waveguide, or increasing the tolerance for misalignment. Of course, in order to increase the coupling efficiency of the optical signals from the light-emitting parts 20 with respect to the light guide plate as the optical waveguide 600, an additional component such as a lens may be used, or a light guide plate applied with a light condensing finishing may be used. Even in a case where one or both of an additional component such as a lens and a light guide plate applied with a light condensing finishing are used, compared to the case of using an optical fiber as the optical waveguide 600, the complexity of positioning can be reduced, or the tolerance for misalignment can be increased. Although the optical waveguide 600 extending in the lamination direction of the unit cells is exemplified, it is also possible to use the optical waveguide 600 extending in a direction perpendicular to the lamination direction of the unit cells. In this case, the light guide plate as the optical waveguide 600 can cover all of the light emitting surfaces of the plurality of light emitting portions 20, and the shape thereof made to be tapered toward the optical output part allows the optical signal output from the tapered optical output part to be received by the light receiving part 80.

As shown in FIG. 2, the optical waveguide 600 is applied with a scattering finishing 60a at a position on the back surface corresponding to the position of the front surface to receive the optical signal. The scattering finishing 60a is applied at a position corresponding to the light-emitting surface of the adjacent or proximate light-emitting part 20. The scattering finishing 60a may be an uneven finishing, for example. A part of the optical signal incident on the optical waveguide 600 and scattered by the scattering finishing 60a propagates in the direction of the optical output part.

Further, the optical waveguide 600 is applied with a reflective finishing 60b on the bent portion, which allows the optical signal scattered by the bent portion to be reflected in the direction of the optical output part. The reflective finishing 60b is applied to the end portion opposite to the end portion that is the optical output part of the optical waveguide 600, which allows the light scattered in the direction opposite to the optical output part to be reflected in the direction of the optical output part.

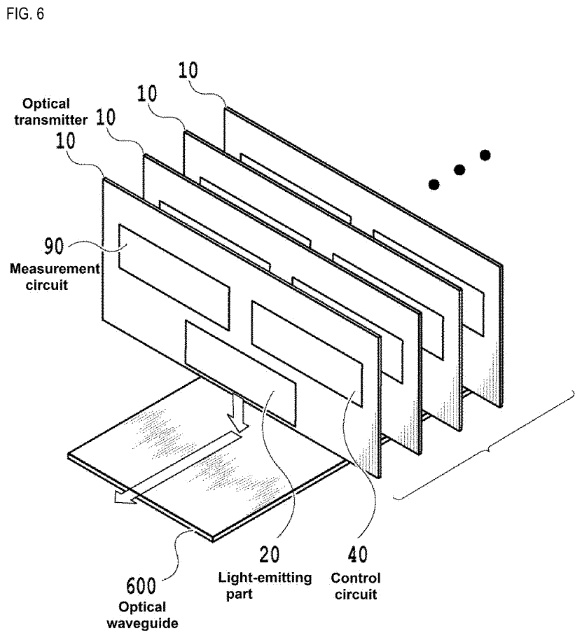

FIG. 6 is a diagram showing a schematic configuration of a plurality of optical transmitters in the optical communication system of an embodiment of the present invention. The optical transmitters 10 correspond to each of the unit cells 30. The optical transmitter 10 is provided with a light-emitting part 20, a control circuit 40, and a measurement circuit 90 arranged on a flexible printed circuit (FPC) (not shown).

The measurement circuit 90 is configured to measure characteristics of the corresponding unit cell 30 and output a characteristic signal representing the measured characteristics. The measurement circuit 90 may be configured using any semiconductor elements such as a microcomputer, an IC, an LSI, or the like. The measurement circuit 90 is supplied with power from the unit cell 30. The measurement circuit 90 may be configured to measure, for example, voltage, temperature, or both as the characteristics of the unit cell. More specifically, the measurement circuit 90 is electrically coupled to voltage measurement terminals (not shown) in contact with the positive electrode current collector and the negative electrode current collector, respectively, and also is electrically coupled with the control circuit 40 that is electrically coupled to the light-emitting part 20. The measurement circuit 90 outputs a binary signal corresponding to the voltage, which is input to a voltage measurement terminal, as a characteristic signal. The measurement circuit 90 outputs a binary signal corresponding to the characteristics of the unit cell 30. For example, the voltage input to the voltage measurement terminal may be converted into a binary signal using a lookup table that defines a voltage range and a corresponding signal pattern, or alternatively, the voltage input to the voltage measurement terminal may be output after being converted to an 8-bit (or 16-bit) binary signal by analog/digital conversion. As an alternative or in addition to the voltage measurement terminals, the measurement circuit 90 may be electrically coupled to one or more temperature measuring elements (not shown) provided in contact with the surface of the positive electrode current collector and the negative electrode current collector or the surface of the unit cell. The measurement circuit 90 outputs a binary signal corresponding to the output from a temperature measuring element as a characteristic signal. The measurement circuit 90 may convert the output from the temperature measuring element into a binary value using, for example, a lookup table that defines the signal pattern corresponding to the output from the temperature measuring element (or the temperature corresponding to the output from the temperature measuring element) and output the converted signal, or the output from the temperature measuring element may be output after being converted into a signal and output, or the output from the temperature measuring element may be converted into an 8-bit (or 16-bit) binary signal by analog/digital conversion. For the voltage and temperature, 8-bit or 16-bit binary signals are exemplary, and the binary signals may contain any number of bits.

The control circuit 40 is configured to receive from the measurement circuit 90 a characteristic signal indicating the characteristics of the corresponding unit cell, and output a control signal obtained by coding the characteristic signal for each predetermined period. The control signal is supplied to the light-emitting part 20. The control circuit 40 may be configured using any semiconductor device such as a microcomputer, an IC, an LSI, or the like. Power is supplied from the unit cell 30. The control circuit 40 may be integrated with the measurement circuit 90. The control circuit may be configured to encode the characteristic signal together with the identifier ID unique to the corresponding unit cell 30, and output the control signal. The optical signal is output based on the control signal in which the identifier ID of the unit cell 30 is encoded in the corresponding control signal together with the characteristic signal, it is possible to decide or estimate on the receiving side of which unit cell the status information is.

The light-emitting part 20 can be configured using a light-emitting element such as an LED element, an organic EL element, etc. The light-emitting part 20 is supplied with power from the unit cell 30, and may be configured to be driven based on the control signal from the control circuit 40 (i.e., emits light in response to the control signal so as to output an optical signal in response to the control signal).

The optical transmitter 10 is provided in the unit cell 30 such that the light-emitting part 20 is arranged on one of the short sides of the unit cell 30. Preferably, with the plurality of unit cells 30 laminated, the light-emitting surfaces of the plurality of light-emitting parts 20 are arranged in a row on the side surface of the assembled battery 50 in the lamination direction of the plurality of unit cells 30, and adjacent or close to the optical waveguide 600.

The optical transmitter 10 is configured to operate with an internal clock. The measurement circuit 90 and the control circuit 40 operate in synchronization with the internal clock. In order to suppress power consumption by the optical transmitter 10, which is supplied with power from the unit cell 30, it is desirable that the clock generation circuit also consumes little power.

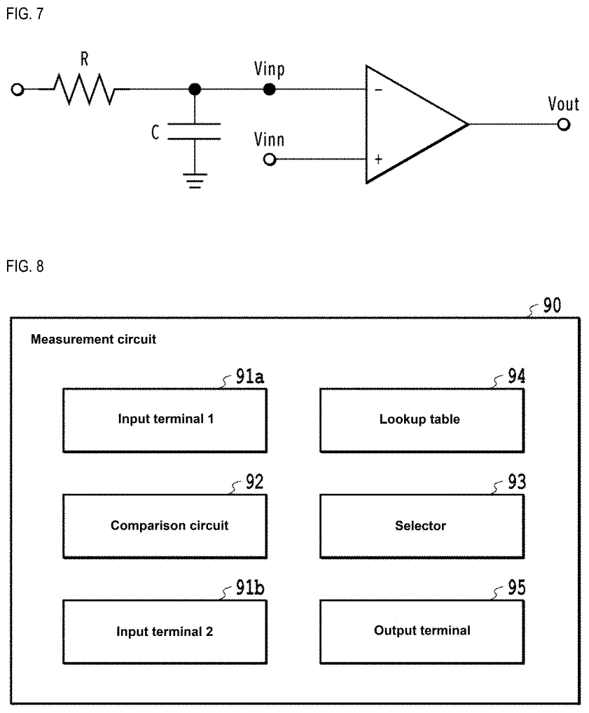

FIG. 7 is a diagram showing a schematic configuration of a clock generation circuit for the optical transmitter in the optical communication system according to an embodiment of the present invention. This clock generation circuit outputs a square wave clock signal by applying a sine wave voltage generated by an oscillator circuit (not shown) such as a Colpitts circuit to one (Vinp) and the other (Vinn) of the two inputs of the comparator. An RC circuit including a resistance R and a capacitance C is connected to Vinp, and the sizes of the resistance R and the capacitance C are decided according to the cycle or frequency of the desired square wave.

FIG. 8 is a functional block diagram of the measurement circuit 90 of the optical transmitter of this embodiment. The measurement circuit 90 is provided with an input terminal 91a and an input terminal 91b, a comparison circuit 92, a lookup table 94, a selector 93, and an output terminal 95.

The input terminal 91a and the input terminal 91b are the terminals for electrically coupling the measurement circuit 90 to each of the voltage measurement terminals in contact with the positive electrode current collector and the negative electrode current collectors of the unit cell 30. Alternatively, the input terminal 91a and the input terminal 91b are the terminals for electrically coupling the measurement circuit 90 to one or more temperature measuring elements (not shown) provided in contact with the surfaces of the positive electrode current collector and the negative electrode current collector of the unit cell 30 or the surface of the unit cell.

The comparison circuit 92 compares the potentials input to the input terminal 91a and the input terminal 91b, and outputs potential difference. The potential difference corresponds to the voltage of the unit cell 30 or the temperature of the unit cell.

The selector 93 selects the binary signal corresponding to the potential difference output from the comparison circuit 92 with reference to the lookup table 94.

The output terminal 95 is a terminal for outputting the binary signal selected by the selector 93 as a characteristic signal corresponding to the characteristics (voltage or temperature) of the unit cell 30.

With the above configuration, each of the plurality of optical transmitters 10 outputs an optical signal corresponding to the characteristics of the corresponding unit cell. Each of the optical transmitters 10 outputs an optical signal asynchronously with other optical transmitters.

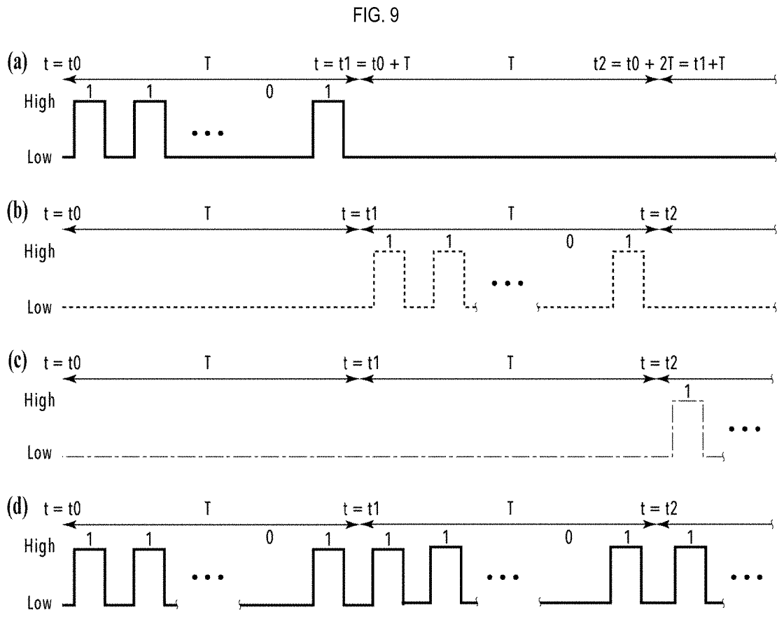

FIG. 9 is a diagram explaining the optical signals transmitted by the plurality of optical transmitters in a certain time period (ideal transmission timing within the system cycle) in the optical communication system of an embodiment of the present invention. The assembled battery 50 consists of n unit cells (n is an integer greater than or equal to 2) laminated each other, and the optical communication system includes n optical transmitters corresponding to each of the n unit cells. Given that the system cycle of the optical communication system is n×T, each of the optical transmitters 10 transmits an optical signal in a time period T within the system cycle. The ideal transmission timing within the system cycle is the timing in which n time periods T of the n optical transmitters 10 in which the optical signals are transmitted do not overlap.

FIGS. 9(a), 9(b), and 9(c) show that at ideal transmission timing within the system cycle, where the optical signals transmitted from three optical transmitters out of the n optical transmitters1 0 are shown on the time axis. FIG. 9(a) shows the optical signals transmitted by a first optical transmitter out of the three optical transmitters in a time period T from t=t0 to t=t1; FIG. 9(b) shows the optical signals transmitted by a second optical transmitter out of the three optical transmitters in a time period T from t=t1 to t=t2; and FIG. 9(c) shows the optical signals transmitted by a third optical transmitter out of the three optical transmitters in a time period T from t=t2 to t=t3. The time period over which the first, second, and third optical transmitters transmit the optical signals is T, and the cycle (repetition time period) is nT. FIG. 9(d) shows the optical signal on the optical waveguide 600 common to n optical transmitters 10 on the time axis. FIG. 9(d) shows the optical signals on the optical waveguide 600 common to n optical transmitters 10 on the time axis. The optical signals shown in FIGS. 9(a), 9(b), and 9(c) do not overlap on the optical waveguide 600, but are received at the light receiving part 80. FIG. 9 shows the case where each of the optical transmitters transmits the optical signal with the same content, however, the contents of the optical signals (the number and pattern of pulses) are variable depending on the state of the unit cell. The maximum number of pulses that can be transmitted in the time period T may be transmitted as an optical signal, or a smaller number of pulses may be transmitted as an optical signal (pulses are transmitted in the first half of time period T and no pulses are transmitted in the second half).

As described above, the optical transmitter 10 is configured to operate with an internal clock. Therefore, the internal clocks of all the optical transmits 10 are not the same, and the timing of transmission of the optical signal deviates. The deviation of the transmission timing of the optical signal increases over time, and returns to the ideal transmission timing during the system cycle again. Assuming that the internal clock of all the optical transmitters 10 are the same, the timing of transmission of two or more optical signals of two or more optical transmissions that send the optical signals in asynchronously may be the same. In this case, the optical signals will continue to overlap on the optical waveguide 600, so that a mechanism to control the transmission timing will be required in the plurality optical transmitters 10, i.e., it is necessary to synchronize the transmission timing among the plurality of optical transmitters 10.

Addition of a mechanism to control the timing of transmission increases in the number of components, the size of the optical transmitter 10, and the number of assembly process, resulting in increase in the cost of the optical transmitter10. Therefore, in the optical communication system of this embodiment, each of the plurality optical transmitters 10 operates with an internal clock to transmit the optical signals asynchronously with the other optical transmitters. More specifically, it is configured in advance that the internal clocks of all the optical transmitters 10 are not the same by adjusting the size of the resistance R and the capacitance C of the RC circuit described above with reference to FIG. 7.

The accuracy of the clock generation circuit of this embodiment described with reference to FIG. 7 is lower than that of a clock generation circuit using a quartz oscillator. The system of a silicon oscillator or a ceramic oscillator implemented in a microcontroller, such as the clock generation circuit in FIG. 7, is 1×10⁻³ to 1 ×10⁻² (0.1% to several percent) and is temperature dependent, whereas the accuracy of a crystal oscillator having a temperature compensation circuit incorporated therewith is on the order of 1×10⁻⁹. Further, the system of a silicon oscillator or a ceramic oscillator in this embodiment includes the deviation from the target accuracy at the time of manufacturing (variation exists in the system). Therefore, the internal clock of an optical transmitter 10 is adjusted not to be the same as the internal clock of other optical transmitter 10 due to the variation at the time of manufacturing and/or the adjustment of the RC circuit.

As described above, the light-emitting part 20 operates and emits light in accordance with the internal clock of the optical transmitter 10. The internal clock of the optical transmitter 10 has temperature dependency. Therefore, the width of the pulse transmitted as an optical signal (length of light emission time) also has a temperature dependency. If the light receiving part 80 converts the optical signal into an electrical signal at a constant sampling interval although the width of the optical pulse varies with temperature, a pulse capture error may occur (i.e., two optical pulses may be converted into one electrical pulse on the side of the light receiving part 80 when the width of the optical pulse is shorter on the side of the light-emitting part 20, or one optical pulse may be converted into two electrical pulses on the side of the light receiving part 80 when the width of the optical pulse is longer on the side of the light-emitting part 20). Therefore, it is desirable that the light receiving part 80 is configured to be provided with a mechanism to change the sampling interval upon converting the received optical signal into an electrical signal in accordance with the temperature dependency of the internal clock of the optical transmitter 10 obtained in advance.

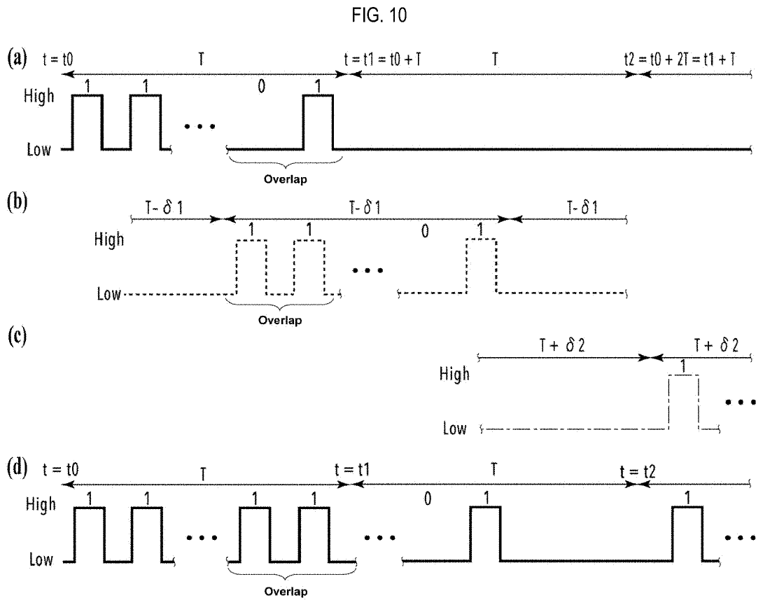

FIG. 10 is a diagram explaining the optical signals transmitted by a plurality of optical transmitters in a certain time period (transmission timing deviating from the ideal transmission timing in the system cycle) in the optical communication system of an embodiment of the present invention. Similar to FIG. 9, FIGS. 10(a), 10(b), and 10(c) are diagrams showing the optical signals transmitted by three optical transmitters out of n optical transmitters 10 on the time axis.

FIG. 10(a) shows the optical signal transmitted by the first optical transmitter in the time period T from t=t0 to t=t1. Based on the internal clock of the first optical transmitter, the cycle of the internal clock in the second optical transmitter is configured to be slightly shorter (with the frequently slightly higher), and therefore the time period for transmitting the optical signal is shorter than T by δ1, and the period (repetition time period) is n(T-δ1). FIG. 10(b) shows the optical signal transmitted by the second optical transmitter in the time period T-δ1 that is deviated from t=t1. The cycle of the internal clock of the third optical transmitter is configured to be slightly longer (with the frequency slightly lower) than the internal clock of the first optical transmitter, and therefore the time period for transmitting the optical signal is shorter than T by δ2, and the cycle (repetition time period) is n(T+δ2). FIG. 10(c) shows the optical signal transmitted by the third optical transmitter in the time period T-δ2 that is deviated from t=t2. FIG. 10(d) is a diagram showing the optical signals on the optical waveguide common to the n optical transmitters 10 on the time axis. The optical signals shown in FIGS. 10(a), 10(b), and 10(c) overlap on the optical waveguide 600 and are received by the light receiving part 80. The optical signals overlap on the optical waveguide 600, so that at least the number of optical pulse, the width of the optical pulse, or the alignment pattern contained in the optical signal in the time period T from t=01 to t=t1, for example is partially changes from the optical pulse contained in the optical signal output from the first optical transmitter. In the example in FIG. 10(d), a second pulse from the last one within the time period T from t=t0 to t=t1 is added, the width of the first pulse from the lase one is widened, and the alignment of the optical pulses within the optical signal is changed. This change also appears in the electrical signal from light receiving part 80. Therefore, based on at least one of the numbers of electrical pulses, the width of electrical pulses, or the alignment of electrical pulses in the electrical signal from the light receiving part 80, it is possible to determine whether at least a part of the plurality of optical signals output from the plurality of optical transmitters 10 overlap on the optical waveguide 600.

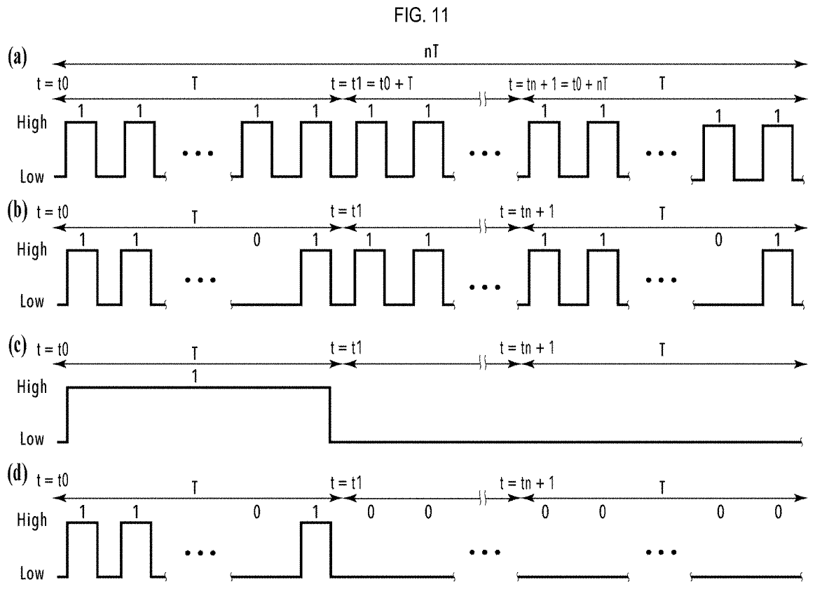

FIG. 11 is a diagram explaining the timing when the optical transmitter sends an optical signal in the optical communication system in an embodiment of the present invention. Taking the first optical transmitter 10 described with reference to FIG. 9 and FIG. 10 as an example, the reference is made as to the timing of sending the optical signal in the time period T from t=0 to t=1 in the time period nT of the system cycle.

FIG. 11(a) is a diagram showing the internal clock of the optical transmitter10 on the time axis. The measurement circuit 90 and the control circuit 40 operate in accordance with the internal clock.

FIG. 11 (b) is a diagram showing a characteristic signal from the measurement circuit 90. In the measurement circuit 90, in accordance with the internal clock, the comparison circuit 92 operates to output a potential difference across the two input terminals (voltage of the unit cell), and the selector 93 operates to select a binary signal corresponding to the potential difference with reference to the lookup table. At this time, a quantization error occurs. The selected binary signal is output as a characteristic signal corresponding to the characteristics (voltage or temperature) of the unit cell 30. FIG. 11 (b) exemplifies the case where the potential difference between the two input terminals of the measurement circuit 90 does not change within the time period of the system cycle from t=0, however, the binary signal (number and pattern of pulse) changes depending on the change in the potential difference between the two input terminals.

FIG. 11(c) is a diagram showing a signal indicating a predetermined time period T (where repetition cycle is NT) in the time period nT of the system cycle. The control circuit 40 can count the time period nT of the system cycle and a predetermined time period T in the time period nT using a clock counter that counts the internal clock so as to generate a signal indicating the prescribed time period. The control circuit 40 encodes the characteristic signal together with a signal showing the predetermined time period to output a control signal. The control signal supplied by the control circuit 40 to the light-emitting portion 20 is the product of the characteristic signal shown in FIG. 11(b) and the signal indicating the predetermined period shown in FIG. 11(c).

FIG. 11(d) is a diagram showing an optical signal output by the light-emitting part 20 emitting light in accordance with a control signal supplied from the control circuit 40. The characteristic signal output from the measurement circuit 90 after t=t1 shown in FIG. 11(b) is not encoded into the control signal (or encoded to be a series of 0), and thus is not output as the optical signal. If the remaining n-1 optical transmitters (for example, the second optical transferee, the third optical transmitter, . . . , n-th optical transmitter) send the optical signals at a different timing from each other during the period after t=t1 within the time period nT in the system cycle, the optical signal are resultingly received at the light receiving part 80, as shown in FIG. 9(d).

As described above, in the ideal transmission timing within the system cycle, the optical signals do not overlap on the common optical waveguide 600, but are received at the light receiving part 80, as shown in FIG. 9(d). In the sending timing deviated from the ideal transmission timing within the system cycle thereafter, as shown in FIG. 10(d), the optical signals overlap on the common optical waveguide 600, and are received at the light receiving part 80. In the ideal transmission timing within the system cycle further thereafter, the optical signals do not overlap on the common optical waveguide 600, but are received at the light receiving part 80, as shown in FIG. 9(d). Thus, in the optical communication system of this embodiment, an ideal transmission timing within the system cycle is generated in a relatively long cycle, and it is possible to decide the characteristics of the plurality of unit cells based on the optical signal received at this time from the plurality of optical transmitters 10.

Reference is made to a method of deciding or estimating the characteristics of the unit cells at the transmission timing that is deviated from the ideal transmission timing within the system cycle shown in FIG. 10(d).

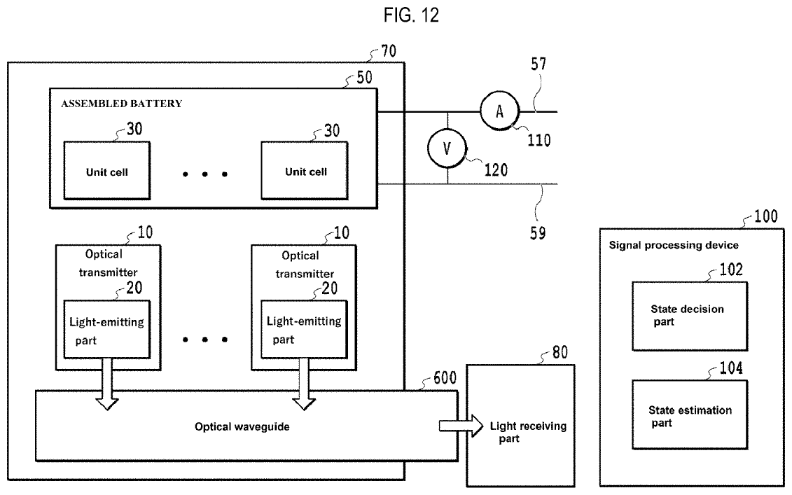

FIG. 12 is a functional block diagram of the optical communication system in an embodiment of the present invention. Considering an additional information different from the electrical signal that the light receiving part 80 converts from the optical signal, the optical communication system is provided with a signal processing device 100 configured to decide or estimate the state of the plurality of unit cells.

As shown in FIG. 12, the lithium-ion battery 1 is provided with a voltmeter 120 for measuring an input/output voltage of the assembled battery connected to the lead wiring 57 and the lead wiring 59. Further, the lithium-ion battery 1 is provided with an ammeter 110 for measuring an input/output current of an assembled battery connected to the lead wiring 57. The input/output voltage information obtained from the voltmeter 120 and the input/output current information obtained from the ammeter 110 can be used as an additional information to decide or estimate the state of the plurality of unit cells. Further, time series and prior knowledge can be used at the time of deciding or estimating the state of the plurality of unit cells. The time series can be an information table in which the state decided by a state decision part 102 is recorded in order of time. The prior knowledge can be an information table showing the correspondence relation between the characteristics of the preset unit cell (internal state such as voltage and temperature, etc.) and the length of the characteristic signal output by the measurement circuit 90, or information indicating the state transition of the characteristics of the unit cell (internal state such as voltage and temperature, etc.). The time series and prior knowledge can be the information recorded in a computer-readable recording medium.

The signal processing device 100 is provided with the state decision part 102 and a state estimation part 104. The signal processing device 100 may be a computing device that is provided with a memory and processor, and a computer-readable storage medium in which a program to make the processor serve as the state decision part 102 and the state estimation part 104. In addition to the program, the computer-readable storage medium may record information indicating the above-mentioned prior knowledge.

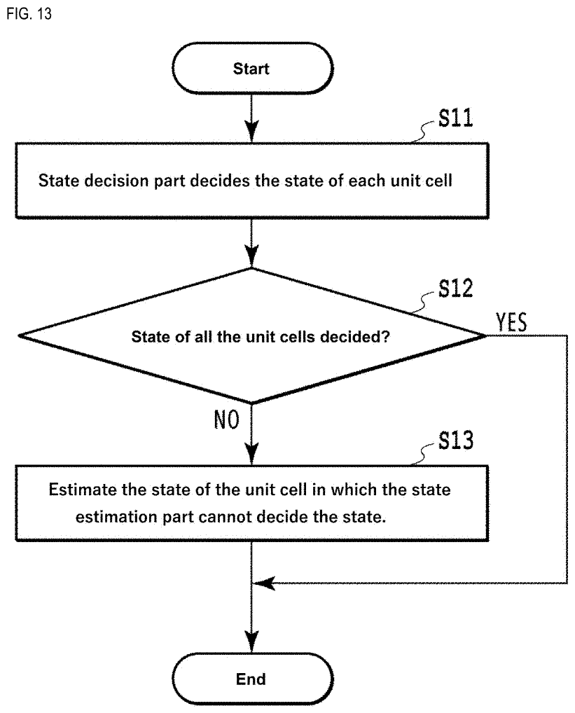

Even at the transmitting timing deviated from the ideal transmission timing within the system cycle, the optical signals sent from a plurality of optical transmission devices are received by the light receiving part 80 as long as they do not overlap, and thus it is possible to correctly decide the characteristics of the unit cell corresponding to the optical transmitter which sent the optical signal concerned. Therefore, as shown in FIG. 13, the state decision part 102 decides the state (characteristics) of the unit cell 30 based on the electrical signal from the light receiving part 80 (step S11), and determine whether or not the decision was made for the states of all the unit cells (step S12), and for the unit cell whose state could not be decided, the state thereof is estimated in the state estimation part 104 (step S13). Hereinafter, a specific example of a method of deciding or estimating the voltage of a unit cell as a characteristic of the unit cell will be described.

The state decision part 102 processes the electrical signal from the light receiving part 80 to decide if the signal is the one converted form the optical signal consisting of two or more optical signals overlapping each other. For example, it is possible to decide whether two or more optical signals overlap based on the number of pulses, the width of the pulse, and the alignment pattern of the pulse contained in the electronic signal. If it is decided that the electrical signal is not converted from the optical signal with two or more optical signals overlapped each other, the state decision part 102 decides the voltage indicated by the electric signal as the voltage of the unit cell 30.

The state estimation part 104 estimates the voltage of the unit cell that was not decided by the state decision part 102. The state estimation part 104 uses input/output voltage information obtained from the voltmeter 120. Given the input/output voltage information as Vtotal of the assembled battery 50 composed of n unit cells 30 connected in series, and the sum of the voltages of the plurality of unit cells as V1+V2+V3+ . . . VN, the relation of Formula 1 is established. The state estimation part 104 transits the voltage of the unit cell that could not be decided by the state decision part 102 by using the relation of Formula 1.

Vtotal=V1+V2+V3+ . . . Vn (Formula 1)

The state estimation part 104 can obtain the difference between Vtotal and the voltage of unit cell that was not decided by the state decision part 102, and, based on the desired difference, estimate the voltage of the unit cell that has not been decided by the state obtained part 102. Here, the voltage of the unit cell decided by the state decision part 102 may include the quantization error in the measurement circuit 90 and the control circuit 40. Therefore, it is preferable to estimate the voltage of the unit cell that has not been decided by the state decision part 102, taking into account the range of this error. Given the number of unit cells that the voltages thereof are decided by the state decision part 102 as m (m is an integer), the lower limit of the voltage represented by the electrical signal as Sm, and the upper limit as SM, the voltage range Vrng_ND of the of the unit cell that was not decided by the state decision part 102 can be expressed by Formula (2). The state estimation part 104 can estimate the voltage of the unit cell that was not decided by the state decision part 102 within this range.

Vtotal−(SM1+SM2+ . . . SMm)<Vrng_ND<Vtotal−(Sm1+Sm2+ . . . Smm) (Formula 2)

Further, the state estimation part 104 can estimate the voltage of the unit cell that was not decided by the state decision part 102 at a certain timing based on the time series. For example, the state estimation part 104 can estimate the voltage of the unit cell that was not decided by the state decision part 102 at a certain timing based on the voltage of the unit cell decided by the state decision part 102 at at least one of the timing before the aforesaid certain timing and the timing after the aforesaid certain timing. For example, given that the voltages of the unit cells decided by the state decision part 102 at t=t0 and t=t2 are equal to V1, based on this time series, the state decision part 104 herein can estimate that the voltage of the unit cell that has not been decided by the state decision part 102 at t=t1 are any of V0 close to V1 (the difference from V1 is not large), V1, or V2 (V0<V1<V2). In another example, given that the voltage of the unit cell decided by the state decision part 102 at t=t0 is V1, and the voltage of the unit cell decided by the state decision part 102 at t=t2 is V3, the state estimation part 104 herein can estimate based on this time series that the voltage of the unit cell that has not been decided by the state decision part 102 at t=t1 is V1 between V1 or V3 close to V1 or V3 (the difference from V1 or V3 is not large), V2 or V3 (V1<V2<V3).

Furthermore, the state estimation part 104 can estimate the voltage of the unit cell that has not been determined by the state decision part 102 at the timing using prior knowledge. As prior knowledge, a voltage-capacity curve measured in advance is held, and the state estimation part 104 can determine the voltage change amount or the voltage after charging the unit cell at a certain voltage to a predetermined amount of power, using a value that fits the voltage-capacity curve.

The state estimation part 104 can estimate the voltage of the unit cell that was not decided by the state decision part 102 at the timing using one or more of estimation using additional information, estimation based on time series, and estimation using prior knowledge.

As described above, while in a time period that deviates from the ideal period within the system cycle, as shown in FIG. 10(d), the optical signals overlaps the optical waveguide 600 and is received by the light receiving part 80, it becomes possible to estimate the state of the unit cell.

The embodiments described above are intended to facilitate understanding of the present invention, and thus are not intended to limit the interpretation of the invention. described in the embodiments. The flowchart, sequence, each element included in the embodiments and its arrangement, materials, conditions, shapes, and sizes are not limited to those illustrated in the examples and can be modified as necessary. It is also possible to replace some or all of the constituent features shown in the different embodiments, or to add and combine the constituent features.

### REFERENCE SIGNS LIST

1 lithium-ion battery
10 optical transmitter
20 light-emitting part
30 unit cell
40 control circuit
50 assembled battery
57,59 lead wiring
60,600 optical waveguide (light guide plate)
60a scattering finishing
60b reflective finishing
70 outer package
80 light receiving part
90 measurement circuit
91a, 91b input terminal
92 comparison circuit
93 selector
94 lookup table
95 output terminal
100 signal processing device
102 state decision part
104 state estimation part
110 ammeter
120 voltmeter

1. A lithium-ion battery, comprising:
a plurality of unit cells that is laminated, each of the unit cells having a measuring part that measures characteristics of the unit cells and a light-emitting part that emits light based on the characteristics of the unit cell and outputs an optical signal;
an optical waveguide arranged adjacent or close to a light-emitting surface of the light-emitting part, the optical waveguide having an optical output part that emits the incident and propagated optical signal; and
an outer package for accommodating the plurality of unit cells and the optical waveguide,
wherein the optical waveguide is a common transmission path the optical signal from the plurality of unit cells.

2. The lithium-ion battery according to claim 1, wherein:
the outer package is made of a laminate film, and
the optical waveguide is made of resin.

3. The lithium-ion battery according to claim 1, wherein:
the width dimension of the optical waveguide perpendicular to the direction of extension of the optical waveguide is greater than the maximum dimension of the luminous surface, and the optical waveguide is arranged to cover the light-emitting surface of the light-emitting part corresponding to the plurality of laminated unit cells.

4. The lithium-ion battery according to claim 1, wherein the optical waveguide is disposed to cover all of the light emitting directions of the light emitting element of the light-emitting part.

5. The lithium-ion battery according to claim 1, wherein the optical waveguide is composed of a material that deforms following the volumetric deformation of the plurality of unit cells.

6. The lithium-ion battery according to claim 2, wherein a part of the optical waveguide is let out from a mountain-folded portion of the laminate film or from a flat portion where the laminate films overlap.

7. The lithium-ion battery according to claim 1, wherein the optical waveguide extends in a direction perpendicular to the lamination direction of the plurality of unit cells, and the width of the optical waveguide decreases toward the optical output part.

8. The lithium-ion battery according to claim 1, wherein a part of the optical waveguide is applied with a scattering finishing or a reflection finish, and the optical signal propagates through the optical waveguide by being scattered or reflected and is output from the optical output part.

9. An optical communication system including a plurality of optical transmitters provided in the plurality of laminated unit cells provided in the lithium-ion battery according to claim 1, each of the unit cells having the corresponding optical transmitter,
wherein each of the optical transmitters comprises:
the measuring part for corresponding unit cell;
the control part configured to receive from the measuring part a characteristic signal indicating the characteristics of the corresponding unit cell, and output a control signal obtained by encoding the characteristic signal for each predetermined period; and
the light-emitting part of the corresponding unit cell, the light-emitting part outputting an optical signal corresponding to the control signal to the common transmission path, and
the plurality of optical transmitters is configured to asynchronously transmit the optical signal.

10. The optical communication system according to claim 9, wherein the control part is configured to output the control signal asynchronously with the control part of other unit cell.

11. The optical communication system according to claim 10, wherein each of the plurality of optical transmitters operates with an individual internal clock, the control part outputs the control signal at a constant cycle based on the individual internal clock, and the internal clocks are different and/or adjusted to be different from each other, so that the constant cycle is different from the constant cycle at which the control part of the other unit cell outputs the control signal.

12. The optical communication system according to claim 9, wherein the measuring part outputs a binary signal corresponding to the characteristics as the characteristic signal.

13. The optical communication system according to claim 9, wherein the characteristics is a voltage of the unit cell or a temperature of the unit cell.

14. The optical communication system according to claim 9, further comprising:
a light receiving part for receiving the optical signal and converting the signal into an electrical signal; and
a signal processing part configured to process the electrical signal to decide or estimate the state of each of the plurality of unit cells.

15. The optical communication system according to claim 14, wherein:
the signal processing part comprises:
a state decision part configured to determine the state of each of the unit cells based on the electrical signal; and
a state estimation part configured to estimate the state of each of the unit cells that the state decision part did not determine the state based on the electrical signal.

16. The optical communication system according to claim 9, comprising:
a light receiving part for receiving the optical signal and converting the signal into an electrical signal; and
a state decision part for determining each of the unit cells based on the electrical signal,
wherein the state decision part:
determines whether or not at least a part of the plurality of optical signals output from the plurality of optical transmitters overlaps on the common transmission path, based on the electrical signal, for each system cycle of the optical communication system; and determine the state of each of the unit cells corresponding to the plurality of optical transmitters based on the electrical signal converted from the optical signal received at the timing determined that at least a part of the plurality of optical signals do not overlap on the common transmission path.

17. The optical communication system according to claim 16, wherein the state decision part determines whether at least a portion of the plurality of optical signals output from the plurality of optical transmitters overlap on the common transmission path based on at least one of the number of pulses, the width of the pulses, or the sequence pattern of the pulses that are contained in the electrical signal.
